(19) United States
(12) Patent Application Publication
(10) Pub. No.: US 2013/0137064 A1
(43) Pub. Date: May 30, 2013

(54) COATED DENTAL CROWNS AND METHOD OF MAKING THE SAME

(71) Applicants: Bhaskar V. Velamakanni, Woodbury, MN (US); Todd D. Jones, St. Paul, MN (US); Anupa N. Patel, Minneapolis, MN (US)

(72) Inventors: Bhaskar V. Velamakanni, Woodbury, MN (US); Todd D. Jones, St. Paul, MN (US); Anupa N. Patel, Minneapolis, MN (US)

(73) Assignee: 3M INNOVATIVE PROPERTIES COMPANY, ST. PAUL, MN (US)

(21) Appl. No.: 13/814,960

(22) PCT Filed: Aug. 8, 2011
(86) PCT No.: PCT/US2011/046920

§ 371 Date: Feb. 8, 2013

Related U.S. Application Data
(60) Provisional application No. 61/372,760, filed on Aug. 11, 2010.

(51) Int. Cl. A61C 5/10; A61C 5/08

(52) U.S. Cl. CPC A61C 5/10; A61C 5/08
USPC 433/222.1; 427/2.29; 118/200

(57) ABSTRACT

Provided are methods of improving the wear resistance and aesthetic properties of dental articles, as well as dental articles having an abrasion resistant ceramic/polymer hybrid coating thereon.

### BACKGROUND

Flexible metal articles are desirable for treatment of a variety of dental maladies. Such articles have proven reasonably durable over both short-term and long-term dental treatment. Dental articles made from or including a malleable metal substrate may typically be modified chair side to adapt to the tooth structures of a particular patient and ensure a secure installation. This degree of post-manufacturing freedom has made malleable metal especially popular as dental crowns and orthodontic bands.

Metal crowns, particularly those made of stainless steel are well suited for children, as their reasonable life span coincides with the natural loss of children's teeth. The metallic sheen of stainless steel, however, is not exactly aesthetically appealing. Accordingly, attempts have been made to apply aesthetic coatings to stainless steel crowns, but these efforts have experienced limited success in maintaining flexibility and durability.

### SUMMARY

Stainless steel and most other untreated or uncoated metals have become increasingly unappealing to patients desiring high-quality aesthetics in addition to high performance and durability. Accordingly, there is an increased demand for dental articles that match or mimic the natural color of teeth. Attempts to meet this demand, including coating with polymer resins, have been thus far been less than desirable. In some prior art solutions, the coating does not sufficiently adhere to the surface during the entirety of treatment or the coating becomes easily stained upon exposure to food. In other prior art solutions, the required coating is so thick that the crown may not be freely manipulated without cracking, potentially requiring substantial removal of the tooth structure for seating the crown. Such substantial removal may lead to increased patient sensitivity and other complications.

The dental articles of the present disclosure include a ceramic/polymer hybrid coating on at least a portion of the article's outer surface. The ceramic/polymer hybrid coatings of the present disclosure can exhibit improved wear and stain resistance while maintaining aesthetic appeal during the full period of treatment. The coatings of the present disclosure can further provide a smooth outer surface for the dental article, reducing patient discomfort upon tongue or lip contact.

Unlike previous aesthetic dental articles, the ceramic/polymer hybrid coated dental articles can maintain desired flexibility such that they may be cut, bent, crimped, or otherwise manipulated by a practitioner without delamination or other failure. Therefore, use of the coated dental articles may allow a dental or orthodontic practitioner to precisely modify the fit or shape of the dental article without sacrificing performance or appearance.

Ceramic/polymer hybrid coated dental articles of the present disclosure may be crimped and/or otherwise manipulated without deleteriously affecting the aesthetics or performance of the coating. The coating is desirably sufficiently thin on the outer surface so as to be pliable enough to undergo manipulation without damage or failure. Preferably, the coating is also sufficiently thick in order to withstand typical mastication (i.e., chewing) and oral preventive care (e.g., brushing) forces throughout the life of the article.

The present disclosure provides for coated dental articles. In one aspect, a dental article includes a first layer of material disposed on and bonded directly to at least a portion of a surface of the dental article, wherein the first layer includes a ceramic material. The dental article further includes a second layer of material disposed on at least a portion of the ceramic material, wherein the second layer includes at least one hardened composition including a polymerizable component.

In certain embodiments, the dental article is a crown and the first layer is disposed substantially above the height of contour.

The present disclosure also provides for methods of coating a dental article. In one aspect, the methods include providing a body comprising a metal substrate and priming at least a portion of a surface of the body. The methods further include depositing a ceramic material on at least a portion of a surface of the body, wherein said depositing forms a ceramic layer bonded directly to the surface; and depositing at least one hardenable composition comprising a polymerizable component on at least a portion of the ceramic layer, wherein depositing at least one hardenable composition forms a polymeric layer.

In certain embodiments, a discontinuous ceramic layer is deposited or created on the surface of the dental article.

In other embodiments, the dental article is a crown and the ceramic layer is deposited substantially above the height of contour.

As used herein, the term “hardenable” refers to a material that can be cured or solidified, e.g., by heating to remove solvent, heating to cause polymerization, chemical crosslinking, radiation-induced polymerization or crosslinking, or the like.

As used herein, “curing” means the hardening or partial hardening of a composition by any mechanism, e.g., by heat, light, radiation, e-beam, microwave, chemical reaction, or combinations thereof.

As used herein, “dental article” means an article that can be adhered (e.g., bonded) to an oral surface (e.g., a tooth structure). Examples include, but are not limited to, replacements, inlays, onlays, veneers, full and partial crowns (both temporary and permanent), bridges, implants, implant abutments, copings, dentures, posts, bridge frameworks and other bridge structures, abutments, orthodontic appliances and devices including, but not limited to archwires, buccal tubes, brackets and bands, and prostheses (e.g., partial or full dentures).

As used herein, the term “ethylenically unsaturated compound” is meant to include monomers, oligomers, and polymers having at least one ethylenic unsaturation.

As used herein, the term “nanofiller” means a filler having an average primary particle size of at most 200 nanometers. The nanofiller component may be a single nanofiller or a combination of nanofillers.

As used herein, the term “(meth)acrylate” is a shorthand reference to acrylate, methacrylate, or combinations thereof, and “(meth)acrylic” is a shorthand reference to acrylic, methacrylic, or combinations thereof. As used herein, “(meth)acrylate-functional compounds” are compounds that include, among other things, a (meth)acrylate moiety.

As used herein, “phosphorylated monomer” refers to a monomer (e.g., a (meth)acrylate) that comprises at least one phosphate or phosphonate group.

As used herein, the term “thermal initiator” means a species capable of efficiently inducing or causing polymerization or crosslinking by exposure to heat.

As used herein, “occlusal” means in a direction toward the outer tips of the patient's teeth.

As used herein, “gingival” means in a direction toward the patient's gums or gingiva.

As used herein, “proximal surface” means the surface nearest to the adjacent tooth.

As used herein, “interproximal” means between the proximal surfaces of adjoining teeth.

As used herein, “anterior crown” means a crown intended to replace incisor and canine teeth.

As used herein, “continuous” means extending substantially across a target surface and including no deliberate gaps or interruptions other those inherent in the material.

As used herein, “height of contour” means the point of greatest convexity of a tooth or crown.

As used herein, deposited or disposed “substantially above the height of contour” and variations mean little to no coating is deliberately deposited the below the height of contour.

As used in the claims, “filler” means nanofiller, other filler, and combinations thereof.

As used herein, “a,” “an,” “the,” “at least one,” and “one or more” are used interchangeably. Thus, for example, a hardenable composition that comprises “a” flexible monomer can be interpreted to mean that the hardenable composition includes “one or more” flexible monomers.

As recited herein, all numbers should be considered modified by the term “about”.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The invention will be further described with reference to the drawings, wherein corresponding reference characters indicate corresponding parts throughout the several views, and wherein:

FIG. 1 is a perspective view of a stainless steel crown.

FIG. 2 is a front plan view of a coated stainless steel crown according to an embodiment of the present disclosure.

FIG. 3 is a cross-sectional view of the stainless steel crown of FIG. 2.

FIG. 4 is a cross-sectional view of a stainless steel crown according to an embodiment of the present disclosure.

FIG. 5 is an enlarged frontal view of a cross-section of a coated stainless steel crown according to an embodiment of the present disclosure.

FIG. 6 is an enlarged frontal view of a cross-section of a coated stainless steel crown according to a further embodiment of the present disclosure.

Layers in the depicted embodiments are for illustrative purposes only and are not intended to define the thickness, relative or otherwise, or the location of any component.

### DETAILED DESCRIPTION OF ILLUSTRATIVE EMBODIMENTS

The dental articles of the present disclosure include a ceramic/polymer hybrid coating on at least a portion of the article's outer surface. The ceramic/polymer hybrid coatings of the present disclosure can exhibit improved wear and stain resistance while maintaining aesthetic appeal during the full period of treatment. Unlike previous aesthetic dental articles, the ceramic/polymer hybrid coated dental articles can maintain desired flexibility such that they may be cut, bent, crimped, or otherwise manipulated by a practitioner without delamination or other failure. Therefore, use of the coated dental articles can allow a dental or orthodontic practitioner to precisely modify the fit or shape of the dental article without sacrificing performance or appearance.

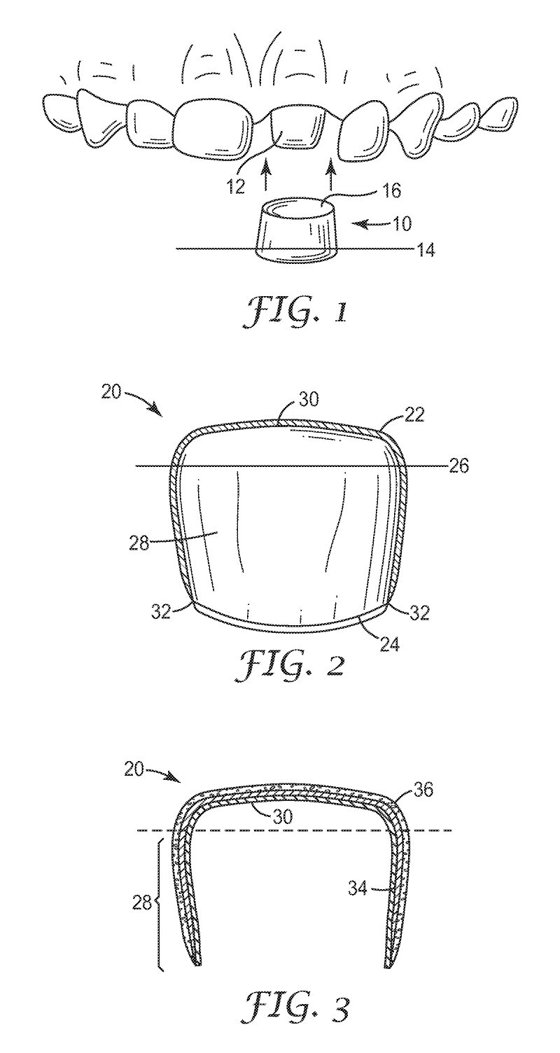

A coated dental article according to one embodiment of the present disclosure is a stainless steel crown (SSC). A typical SSC is constructed from a preformed base material crown 10 composed of stainless steel, which is placed in the mouth to cover a prepared tooth 12 as shown in FIG. 1. The prepared tooth 12 is shown as having its surface ground away sufficient for the placement of the crown 10 thereon. The scale of the teeth shown and the crown 10 to be placed thereon is for ease of illustration and should not be considered to be at the correct scale. Furthermore, the portion of the tooth 12, which has been ground away, is also for illustration purposes only. As shown in FIG. 1, the base metal crown 10, which as shown for illustration purposes, is not a molar, and therefore can be pictured generally as a flattened bowl which is formed in the shape of a tooth with an open end 16 for placement over the prepared tooth 12. Proper tooth preparation includes removing all caries and proper shaping of the remaining natural tooth 12 to receive the SSC 10. Therefore, the prepared tooth 12 is typically left in place in the mouth so that its root provides anchor in the jaw for the SSC 10. The SSC 10 shown in FIG. 1 is an anterior crown; however, it is to be understood that the present disclosure is applicable to both anterior and to posterior crowns as well.

Typically an SSC is shaped to resemble the tooth that it replaces and is sized to fit comfortably over the portion of the tooth on which the dental procedure is being performed. The crown is trimmed so that the bottom edge of the crown meets the gum line in a comfortable manner approximating the placement of the tooth when the crown is applied. The crowns are manufactured in sizes and shapes to fit the various types of teeth. The stainless steel is preferably malleable so it can be crimped around the base of the tooth and shaped on the occlusal surface to provide a comfortable bite with the opposing tooth. Precise adjustments by a practitioner to the shape and/or size the SSC are often, though not always, made to the portion of the SSC below the height of contour 14.

Commercially available preformed stainless steel crowns can be obtained from 3M Company, St. Paul, Minn. Other sources of preformed stainless steel crowns include Acero XT, Dallas, Tex. and Denovo Dental, Baldwin Park, Calif.

The preformed base metal in a SSC is typically constructed of cold rolled stainless steel. Prior to coating, the crown can be prepared to remove oil or other surface contaminants by vapor degreasing, alkaline cleaning, acetone cleaning, or ultra-sonic cleaning, for example, as needed. Surface oxides may be removed and surface activation can be accomplished by acid treatment or abrasive blasting, for example, as described in more detail below.

Typical stainless steel materials used to construct stainless steel crowns useful in the present disclosure include AISI-Types 304, 305, and 316 stainless steel sheeting (based on the American Iron and Steel Institute Classification of Chromium-Nickel Stainless Steels). Such sheeting includes a metal alloy of iron, chromium, and nickel typically with small or trace amounts of manganese, carbon, titanium, aluminum, silicon, tantalum, and molybdenum.

FIG. 2 depicts a front plan view of an aesthetic posterior SSC 20, including a ceramic/polymer hybrid coating 22. The exterior of the crown includes a height of contour 26 extending across the wall surface 28 below occlusal surface 30 as it transitions into an integral circumferential area or continuous wall. In the depicted embodiment, portions of the cervical margin, including those proximate the gingival-labial and the gingival-lingual edge regions 32 are left uncoated to allow for more precise manipulation and trimming. It is further contemplated that the entire outer surface of the SSC may be coated with the ceramic/polymer hybrid coating, including the cervical margins.

Though not depicted, it is also contemplated that the coatings of the present disclosure be used on anterior crowns. In some embodiments, the entire outer surface of the anterior crown may be coated. In other embodiments, only the portion of the anterior crown coming into contact with the opposing dentition (e.g., an incisal surface) or above the height of contour need be coated. Other portions of an anterior crown may be coated as desired.

FIG. 3 illustrates a cross-sectional view of the coated SSC 20 of FIG. 2. The outer surface may be primed to include micro texture (e.g., abraded, deposited, or etched) according to methods described herein. A ceramic layer 34 including a ceramic material is disposed on the surface 30. As depicted in FIG. 3, the ceramic layer is continuous over the entire coated surface. A polymeric layer 36 comprising a hardened dental composition is disposed on top of the ceramic layer 34.

One or more additional polymeric layers are also contemplated (though not depicted), so that a coated dental article may include a plurality of polymeric layers. Suitable additional polymeric layers include those described in copending application entitled POLYMER COATED DENTAL ARTICLES AND METHOD OF MAKING THE SAME, filed on Aug. 11, 2011 under attorney docket number 66143US002.

In some embodiments, the thickness of the coating layer is substantially consistent over the entire coated surface of the dental article. In other embodiments, the coating may include a thickness gradient. Such a gradient may include a gradual decrease or an abrupt decrease in coating thickness, or a combination thereof. For example, the thickness of the coating on the occlusal surface 30 may be greater than the thickness of the coating on the wall surfaces 28 (e.g., the interproximal surfaces) proximate the height of contour. Further, the coating thickness may then approach zero as the cervical margin is approached in a gingival direction. It is also contemplated that the thickness of the coating on the occlusal surface 30 be less than the thickness of the coating on the wall surfaces 28. In one embodiment, the thickness of the ceramic/polymer coating at its thickest point, as measured from the surface of the dental article, may be no greater than 500 microns. In a further embodiment, the coating at the thickest point is no greater than 200 microns thick. In a further embodiment, the coating at the thickest point is less than 150 microns thick.

In certain preferred embodiments, the ceramic layer is sufficiently thick to ensure wear resistance and aesthetic preferences. In one embodiment, the ceramic layer is at least 20 microns thick. In a further embodiment, the ceramic layer is at least 55 microns thick. In a stainless steel crown including a thickness gradient as described above, it should be appreciated that the minimum thickness is in reference to the thickness of the ceramic layer 34 on the occlusal surface 30. In one embodiment, the thickness 20 of the ceramic layer is no greater than 150 microns. In a further embodiment, the thickness of the ceramic layer is no greater than 100 microns. In a further embodiment, the thickness of the ceramic layer is no greater than 75 microns.

In one embodiment, the thickness of the one or more polymeric layers is no less than 5 microns. In another embodiment, the thickness of the one or more polymeric layers is no less than 10 microns. In a further embodiment, the thickness of the one or more polymeric layers is no less than 20 microns. In one embodiment, the thickness of the one or more polymeric layers is no greater than 300 microns. In another embodiment, the thickness of the one or more polymeric layers is no greater than 150 microns. In a further embodiment, the thickness of the one or more polymeric layers is no greater than 50 microns.

As noted above, the thickness of the coating may approach zero on portions of the gingival or interproximal surfaces. In certain embodiments, the thickness of the coating on the wall surfaces below the height of contour is no greater than 150 microns, in other embodiments less than 100 microns, in yet other embodiments less than 50 microns. In a further embodiment, the thickness of the coating on the wall surfaces below the height of contour is no greater than 30 microns. Thicknesses exceeding 150 microns may not provide sufficient flexibility in certain embodiments.

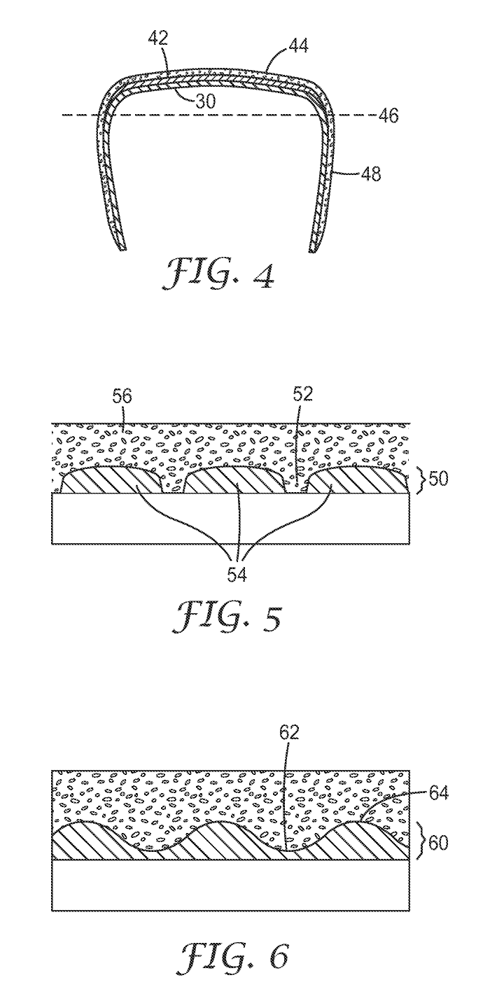

FIG. 4 depicts an embodiment of an SSC 40 that includes the ceramic layer 42 on only a portion of the outer surface. The ceramic layer 42 is disposed on at least a portion of the occlusal surface 44, with little to no coverage below the height of contour 46. The ceramic layer 42 may be continuous over at least a portion of the occlusal surface 44 or may be discontinuous, as discussed below. A polymeric layer 48 of the one or more polymeric layers is deposited on substantially the entire outer surface, although the cervical margins may remain uncoated in any embodiment for precise manipulation and trimming.

The ceramic layer may be discontinuous (e.g., patterned) on the coated surface of the SSC. One embodiment of a discontinuous ceramic layer 50 on a surface is illustrated in FIG. 5. Such a discontinuous layer includes gaps 52 (i.e., pores or apertures) between deposits of ceramic material 54. In the depicted an embodiment, a polymeric layer 56 or polymeric layers (not depicted) may partially or completely fill the gaps 52 between the ceramic deposits 54. Without wishing to be bound by theory, the gaps 52 in the discontinuous ceramic layer may improve the ceramic/polymer appearance and flexibility, as well as the adhesion of the one or more polymeric layers to the dental article surface. In some embodiments, the discontinuous ceramic layer includes an identifiable pattern of alternating gaps and ceramic deposits. In other embodiments, the ceramic layer is irregular or otherwise non-patterned (e.g., varying distances between deposits). Other embodiments may include a combination of patterned and non-patterned sections of the ceramic layer.

It is also contemplated that the ceramic layer can be substantially continuous over at least a portion of the outer surface, but may comprise discrete ceramic sections of varying thickness. Such an embodiment is depicted in FIG. 6. The ceramic layer 60 includes apparent peaks 64 and valleys 62. The valleys 62 (i.e., areas of the surface have a thinner coating section) may be sufficiently thin so as to enable flexibility of the overall coating construction. In one embodiment, the pitch of the structured ceramic surface (i.e. the distance between repeating peaks 64) may be on a length-scale such that it is not readily visible to the unassisted eye. Accordingly, the pitch in one embodiment is 0.2 mm, in another embodiment 0.1 mm, and in a further embodiment 0.05 mm. Furthermore, the ratio of the area of the valleys 62 to the area of the peaks 50 in the structured surface in one embodiment may be at least 0.3, in another embodiment at least 0.5 and in a further embodiment at least 0.7.

Without wishing to be bound by theory, a hardenable composition of the one or more polymeric layers may penetrate openings in continuous (e.g., micropores) and discontinuous layers form an interpenetrating network (IPN).

Suitable ceramic materials for use in a ceramic layer include, but are not limited to, alumina, zirconia, yttria, yttria-stabilized zirconia, porcelain, blends and other combinations thereof. Particularly useful ceramic materials exhibit a color similar to a patient's tooth (e.g., white) when deposited on the surface of the dental article.

Exemplary hardenable compositions useful for creating the one or more polymeric layers include at least one of a polymerizable component, an initiator system, a pigment, a nanofiller, a filler, and other additives (e.g., solvents). The potential components of the hardenable composition are described in more detail below.

### Polymerizable Component

The hardenable compositions of the present disclosure are typically hardenable due the presence of a polymerizable component. In some embodiments, the compositions can be hardened (e.g., polymerized by conventional photopolymerization and/or chemical polymerization techniques) after it has been applied to the surface of a dental article.

In certain embodiments, the compositions are photopolymerizable, i.e., the compositions contain a photoinitiator system that upon irradiation with actinic radiation initiates the polymerization (or hardening) of the composition. In other embodiments, the compositions are chemically hardenable, i.e., the compositions contain a chemical initiator (i.e., initiator system) that can polymerize, cure, or otherwise harden the composition without dependence on irradiation with actinic radiation. Such chemically hardenable compositions are sometimes referred to as “self-cure” compositions.

In other embodiments, the compositions are thermally polymerizable, i.e., the compositions contain a thermal initiator system that upon heating or other application of thermal energy initiates the polymerization (or hardening) of the composition.

The polymerizable component typically comprises one or more ethylenically unsaturated compounds, with or without acid functionality. Examples of useful ethylenically unsaturated compounds include acrylic acid esters, methacrylic acid esters, hydroxy-functional acrylic acid esters, hydroxy-functional methacrylic acid esters, and combinations thereof. The polymerizable component may comprise one or more ethylenically unsaturated compounds, with or without acid functionality that is phosphorylated, such as a phosphorylated methacrylate.

The compositions, especially in photopolymerizable implementations, may include compounds having free radically active functional groups that may include monomers, oligomers, and polymers having one or more ethylenically unsaturated group. Suitable compounds contain at least one ethylenically unsaturated bond and are capable of undergoing addition polymerization. Such free radically polymerizable compounds include mono-, di- or poly-(meth)acrylates (i.e., acrylates and methacrylates) such as, methyl(meth)acrylate, ethyl acrylate, isopropyl methacrylate, n-hexyl acrylate, stearyl acrylate, allyl acrylate, glycerol triacrylate, ethyleneglycol diacrylate, diethyleneglycol diacrylate, triethyleneglycol dimethacrylate, 1,3-propanediol di(meth)acrylate, trimethylolpropane triacrylate, 1,2,4-butanetriol trimethacrylate, 1,4-cyclohexanediol diacrylate, pentaerythritol tetra(meth)acrylate, sorbitol hexacrylate, tetrahydrofurfuryl(meth)acrylate, bis[1-(2-acryloxy)]-p-ethoxyphenyldimethylmethane, bis[1-(3-acryloxy-2-hydroxy)]-p-propoxyphenyldimethylmethane, ethoxylated bisphenolA di(meth)acrylate, and trishydroxyethyl-isocyanurate trimethacrylate; (meth)acrylamides (i.e., acrylamides and methacrylamides) such as (meth)acrylamide, methylene bis-(meth)acrylamide, and diacetone(meth)acrylamide; urethane meth)acrylates; the bis-(meth)acrylates of polyethylene glycols (preferably of molecular weight 200-500), copolymerizable mixtures of acrylated monomers such as those in U.S. Pat. No. 4,652, 274 (Boettcher et al.), acrylated oligomers such as those of U.S. Pat. No. 4,642,126 (Zador et al.), and poly(ethylenically unsaturated) carbamoyl isocyanurates such as those disclosed in U.S. Pat. No. 4,648,843 (Mitra); and vinyl compounds such as styrene, diallyl phthalate, divinyl succinate, divinyl adipate and divinyl phthalate. Other suitable free radically polymerizable compounds include siloxane-functional (meth)acrylates as disclosed, for example, in WO-00/38619 (Guggenberger et al.), WO-01/92271 (Weinmann et al.), WO-01/07444 (Guggenberger et al.), WO-00/42092 (Guggenberger et al.) and fluoropolymer-functional (meth)acrylates as disclosed, for example, in U.S. Pat. No. 5,076,844 (Fock et al.), U.S. Pat. No. 4,356,296 (Griffith et al.), EP-0373 384 (Wagenknecht et al.), EP-0201 031 (Reiners et al.), and EP-0201 778 (Reiners et al.). Mixtures of two or more free radically polymerizable compounds can be used if desired.

The polymerizable component may also comprise monomers that are curable by ring-opening metathesis polymerization (ROMP) having at least one functionality curable by ROMP, such as at least one endocyclic olefinically unsaturated doublebond. Generally, suitable monomers can follow the general formula B-Aₙ wherein A is a moiety polymerizable by ROMP such as cyclobutenyl, cyclopentenyl, cyclooctenyl or bicyclic ring systems like the often preferred norbornenyl and 7-oxa-norbornenyl groups, and B is an organic or silicon-organic backbone with 1 to 100, e.g., 1 to 10 or 1 to 5 or 1 to 4 moieties polymerizable by ROMP, e.g., 2 or 3 moieties polymerizable by ROMP, are attached, n being 1 to 100. The composition according to the disclosure may contain only one type of monomer according to the general formula B-Aₙ. It is also possible that a composition according to the disclosure contains two or more different types of monomers according to the general formula B-Aₙ. In some embodiments, the composition contains at least one type of monomer according to the general formula B-Aₙ, which has one or two olefinically unsaturated double bonds which are curable by ROMP. Suitable monomers are described, for example, in great detail in US Patent Publication No. 2009/00884 (Luchterhandt et al.).

The polymerizable component may also contain hydroxyl groups and ethylenically unsaturated groups in a single molecule. Examples of such materials include hydroxyalkyl(meth)acrylates, such as 2-hydroxyethyl(meth)acrylate and 2-hydroxypropyl(meth)acrylate; glycerol mono- or di-(meth)acrylate; trimethylolpropane mono- or di-(meth)acrylate; pentaerythritol mono-, di-, and tri-(meth)acrylate; sorbitol mono-, di-, tri-, tetra-, or penta-(meth)acrylate; and 2,2-bis[4-(2-hydroxy-3-methacryloxypropoxy)phenyl]propane (bisGMA). Suitable ethylenically unsaturated compounds are available from a wide variety of commercial sources, such as Sigma-Aldrich, St. Louis. Mixtures of ethylenically unsaturated compounds can be used if desired.

In certain embodiments, the polymerizable component may include, bisGMA, UDMA (urethane dimethacrylate), GDMA (glycerol dimethacrylate), TEGDMA (triethyleneglycol dimethacrylate), bisEMA6 as described in U.S. Pat. No. 6,030,606 (Holmes), phenoxyethylmethacrylate, and/or NPGDMA (neopentylglycol dimethacrylate). The polymerizable component may include combinations of these hardenable components.

In some embodiments, the polymerizable component may include one or more ethylenically unsaturated compounds with acid functionality. As used herein, ethylenically unsaturated compounds “with acid functionality” is meant to include monomers, oligomers, and polymers having ethylenic unsaturation and acid and/or acid-precursor functionality. Acid-precursor functionalities include, for example, anhydrides, acid halides, and pyrophosphates. The acid functionality can include carboxylic acid functionality, phosphoric acid functionality, phosphonic acid functionality, sulfonic acid functionality, or combinations thereof.

Ethylenically unsaturated compounds with acid functionality include, for example, α,β-unsaturated acidic compounds such as glycerol phosphate mono(meth)acrylates, glycerol phosphate di(meth)acrylates, hydroxyethyl(meth)acrylate (e.g., HEMA) phosphates, bis((meth)acryloxyethyl)phosphate, ((meth)acryloxypropyl)phosphate, bis((meth)acryloxypropyl)phosphate, bis((meth)acryloxy)propyloxy phosphate, (meth)acryloxyhexyl phosphate, bis((meth)acryloxyhexyl)phosphate, (meth)acryloxyoctyl phosphate, bis((meth)acryloxyoctyl)phosphate, (meth)acryloxydecyl phosphate, bis((meth)acryloxydecyl)phosphate, caprolactone methacrylate phosphate, citric acid di- or tri-methacrylates, poly(meth)acrylated oligomaleic acid, poly(meth)acrylated polymaleic acid, poly(meth)acrylated poly(meth)acrylic acid, poly(meth)acrylated polycarboxyl-polyphosphonic acid, poly(meth)acrylated polychlorophosphoric acid, poly(meth)acrylated polysulfonate, poly(meth)acrylated polyboric acid, and the like, may be used as components in the hardenable component system. Also monomers, oligomers, and polymers of unsaturated carbonic acids such as (meth)acrylic acids, aromatic(meth)acrylated acids (e.g., methacrylated trimellitic acids), and anhydrides thereof can be used. Certain embodiments of the composition of the present disclosure include an ethylenically unsaturated compound with acid functionality having at least one P—OH moiety.

Certain of these compounds are obtained, for example, as reaction products between isocyanatoalkyl(meth)acrylates and carboxylic acids. Additional compounds of this type having both acid-functional and ethylenically unsaturated components are described in U.S. Pat. No. 4,872,936 (Engelbrecht) and U.S. Pat. No. 5,130,347 (Mitra). A wide variety of such compounds containing both the ethylenically unsaturated and acid moieties can be used. Mixtures of such compounds can be used if desired.

Additional ethylenically unsaturated compounds with acid functionality include, for example, polymerizable bisphosphonic acids as disclosed for example, in U.S. Patent Application Publication No. 2009-0075239 (Abuelyaman); AA:ITA:IEM (copolymer of acrylic acid:itaconic acid with pendent methacrylate made by reacting AA:ITA copolymer with sufficient 2-isocyanatoethyl methacrylate to convert a portion of the acid groups of the copolymer to pendent methacrylate groups as described, for example, in Example 11 of U.S. Pat. No. 5,130,347 (Mitra)); and those recited in U.S. Pat. No. 4,259,075 (Yamauchi et al.), U.S. Pat. No. 4,499,251 (Omura et al.), U.S. Pat. No. 4,537,940 (Omura et al.), U.S. Pat. No. 4,539,382 (Omura et al.), U.S. Pat. No. 5,530,038 (Yamamoto et al.), U.S. Pat. No. 6,458,868 (Okada et al.), and European Pat. Application Publication Nos. EP 712,622 (Tokuyama Corp.) and EP 1,051,961 (Kuraray Co., Ltd.).

Compositions of the present disclosure can also include combinations of ethylenically unsaturated compounds with acid functionality as described, for example, in U.S. Patent Application Publication No. 2007/0248927 (Luchterhandt et al.). The compositions may also include a mixture of ethylenically unsaturated compounds both with and without acid functionality.

Polymerizable components may also include flexible monomers and multimethacrylate oligomers, including but not limited to, phenoxyethylmethacrylate, trimethylcyclohexylmethacrylate, C8-C18 monomethacrylates, PEGDMA (polyethyleneglycol dimethacrylate having a molecular weight of approximately 400), aliphatic urethane methacrylates, aliphatic polyester urethane methacrylates, aliphatic polyester triurethane acrylates. Further contemplated are reactions products of isocyanatoethylmethacrylate with polytetramethylene ether diols and/or polycaprolactone polyols. In certain embodiments, the flexible monomers and/or oligomers have a glass transition temperature of no greater than 60 degrees Celsius.

Adding the monomers and multimethacrylate oligomers to a hardenable composition may create a composition having improved flexibility as evidenced by, for example, having at least a 3% elongation to break or ability to bend around at least an 8 mm mandrel. In certain preferred embodiments, the hardenable compositions deposited on wall surfaces below the height of contour include a flexible monomer or oligomer.

An exemplary self-cure system comprising aliphatic polyisocyanates is described in U.S. Pat. Nos. 7,189,429 and 6,730,353 (Robinson). The first part of this two-part system includes one or more aliphatic polyisocyanates. Suitable polyisocyanates include derivatives of hexamethylene-1,6-diisocyanate; 2,2,4-trimethylhexamethylene diisocyanate; isophorone diisocyanate; and 4,4′dicyclohexylmethane diisocyanate. Preferred polyisocyanates are the uretdione, biuret and isocyanurate trimer of hexamethylene-1,6-diisocyanate, with the uretdione being particularly preferred.

The preferred polyisocyanates have an isocyanate content of 15 to 30%, with an isocyanate content of 20 to 25% being particularly preferred. The aliphatic polyisocyanates may further be blended with one or more amine reactive resins and/or non-reactive resins.

The second part of a two-part coating system comprises one or more polyamines. The one or more polyamines are preferably aromatic. Suitable polyamines include diethyl toluenediamine; dimethylthio toluenediamine; 4,4′-methylenebis (2-isopropyl-6-methylaniline); and 4,4′-methylenebis (3-chloro-2,6-diethylaniline). The polyamines may further be blended with polyhydric alcohol. The polyhydric alcohol compounds can be polyester or polyether polyols containing at least two hydroxyl groups per molecule. Branched polyether-esters are particularly useful.

In another embodiment of the two-part coating system, the aromatic polyamines may be blended with oligomeric polyamines. Suitable compounds include poly(oxypropylene)diamines, poly(oxypropylene)triamines, poly(oxytetramethylene)-di-p-aminobenzoates.

Additional flexible components suitable for use in certain two-part systems include polyTHF, polyethyleneoxide, and polypropylene oxide.

### Initiator Systems

In certain embodiments, the hardenable compositions of the present disclosure are photopolymerizable, i.e., the hardenable compositions contain a photopolymerizable component and a photoinitiator system that upon irradiation with actinic radiation initiates the polymerization (or hardening) of the composition. Such photopolymerizable compositions can be free radically polymerizable or cationically polymerizable.

Suitable photoinitiators (i.e., photoinitiator systems that include one or more compounds) for polymerizing free radically photopolymerizable compositions include binary and tertiary systems. Typical tertiary photoinitiators include an iodonium salt, a photosensitizer, and an electron donor compound as described in U.S. Pat. No. 5,545,676 (Palazzotto et al.). Suitable iodonium salts are the diaryl iodonium salts, e.g., diphenyliodonium chloride, diphenyliodonium hexafluorophosphate, diphenyliodonium tetrafluoroborate, and tolylcumyliodonium tetrakis(pentafluorophenyl)borate. Suitable photosensitizers are monoketones and diketones that absorb some light within a range of 400 nm to 520 nm (preferably, 450 nm to 500 nm). Particularly suitable compounds include alpha diketones that have light absorption within a range of 400 nm to 520 nm (even more preferably, 450 to 500 nm). Suitable compounds are camphorquinone, benzil, furil, 3,3,6,6-tetramethylcyclohexanedione, phenanthraquinone, 1-phenyl-1,2-propanedione and other 1-aryl-2-alkyl-1,2-ethanediones, and cyclic alpha diketones. Suitable electron donor compounds include substituted amines, e.g., ethyl dimethylaminobenzoate. Other suitable tertiary photoinitiator systems useful for photopolymerizing cationically polymerizable resins are described, for example, in U.S. Pat. No. 6,765,036 (Dede et al.).

Other useful photoinitiators for polymerizing free radically photopolymerizable compositions include the class of phosphine oxides that typically have a functional wavelength range of 380 nm to 1200 nm. Suitable phosphine oxide free radical initiators with a functional wavelength range of 380 nm to 450 nm are acyl and bisacyl phosphine oxides such as those described in U.S. Pat. No. 4,298,738 (Lechtken et al.), U.S. Pat. No. 4,324,744 (Lechtken et al.), U.S. Pat. No. 4,385,109 (Lechtken et al.), U.S. Pat. No. 4,710,523 (Lechtken et al.), and U.S. Pat. No. 4,737,593 (Ellrich et al.), U.S. Pat. No. 6,251,963 (Kohler et al.); and EP Application No. 0 173 567 A2 (Ying).

Commercially available phosphine oxide photoinitiators capable of free-radical initiation when irradiated at wavelength ranges of greater than 380 nm to 450 nm include bis(2,4,6-trimethylbenzoyl)phenyl phosphine oxide (IRGACURE 819, Ciba Specialty Chemicals, Tarrytown, N.Y.), bis(2,6-dimethoxybenzoyl)-(2,4,4-trimethylpentyl) phosphine oxide (CGI 403, Ciba Specialty Chemicals), a 25:75 mixture, by weight, of bis(2,6-dimethoxybenzoyl)-2,4,4-trimethylpentyl phosphine oxide and 2-hydroxy-2-methyl-1-phenylpropan-1-one (IRGACURE 1700, Ciba Specialty Chemicals), a 1:1 mixture, by weight, of bis(2,4,6-trimethylbenzoyl)phenyl phosphine oxide and 2-hydroxy-2-methyl-1-phenylpropane-1-one (DAROCUR 4265, Ciba Specialty Chemicals), and ethyl 2,4,6-trimethylbenzylphenyl phosphinate (LUCIRIN LR8893X, BASF Corp., Charlotte, N.C.).

Typically, the phosphine oxide initiator is present in the photopolymerizable composition in catalytically effective amounts, such as from 0.1 weight percent to 5.0 weight percent, based on the total weight of the unfilled composition.

Tertiary amine reducing agents may be used in combination with an acylphosphine oxide. Illustrative tertiary amines useful in the disclosure include ethyl 4-(N,N-dimethylamino)benzoate and N,N-dimethylaminoethyl methacrylate. When present, the amine reducing agent is present in the photopolymerizable composition in an amount from 0.1 weight percent to 5.0 weight percent, based on the total weight of the unfilled composition. Useful amounts of other initiators are well known to those of skill in the art.

In certain embodiments, the compositions of the present disclosure are chemically hardenable, i.e., the compositions contain a chemically hardenable component and a chemical initiator (i.e., initiator system) that can polymerize, cure, or otherwise harden the composition without dependence on irradiation with actinic radiation. Such chemically hardenable compositions are sometimes referred to as “self-cure” compositions.

In embodiments wherein the hardenable composition includes a monomer or oligomer curable by ROMP, suitable initiators include all substances which are able to initiate a ROMP polymerization in a curable composition. It is preferred that a polymer composition comprising an ROMP initiator is sufficiently chemically stable at ambient temperature, generally at room temperature or temperatures up to 60° C., providing unhindered preparation and molding of the formulation.

Suitable chemically stable initiators do not lead to an increase of viscosity of the composition of more than 10% during a minimum of 5 hours at temperatures below 50° C. It is also preferred that a suitable initiator will cure the formulation within 24 hours at a temperature above 100° C. by ROMP reaction. Preferred initiators are metal complexes of ruthenium or osmium not bearing a carbene function. Examples of suitable initiators can be found in Castarlenas et al., Journal of Organometallic Chemistr, 663 (2002) 235-238 and in Hafner et al., Angew. Chem. 1997, 109, Nr. 19, S. 2213. Further preferred initiators are disclosed in U.S. Pat. No. 6,001,909 (Setiabudi) and US Patent Publication No. 2009/00884 (Luchterhandt et al.).

The chemically hardenable compositions may include redox cure systems that include a polymerizable component (e.g., an ethylenically unsaturated polymerizable component) and redox agents that include an oxidizing agent and a reducing agent. Suitable polymerizable components, redox agents, optional acid-functional components, and optional fillers that are useful in the present disclosure are described in U.S. Pat. Publication Nos. 2003/0166740 (Mitra et al.) and 2003/0195273 (Mitra et al.).

The reducing and oxidizing agents should react with or otherwise cooperate with one another to produce free-radicals capable of initiating polymerization of the resin system (e.g., the ethylenically unsaturated component). This type of cure is a dark reaction, that is, it is not dependent on the presence of light and can proceed in the absence of light. The reducing and oxidizing agents are preferably sufficiently shelf-stable and free of undesirable colorization to permit their storage and use under typical dental conditions. They should be sufficiently miscible with the resin system (and preferably water-soluble) to permit ready dissolution in (and discourage separation from) the other components of the composition.

Useful reducing agents include ascorbic acid, ascorbic acid derivatives, and metal complexed ascorbic acid compounds as described in U.S. Pat. No. 5,501,727 (Wang et al.); amines, especially tertiary amines, such as 4-tert-butyl dimethylaniline; aromatic sulfinic salts, such as p-toluenesulfinic salts and benzenesulfinic salts; thioureas, such as 1-ethyl-2-thiourea, tetraethyl thiourea, tetramethyl thiourea, 1,1-dibutyl thiourea, and 1,3-dibutyl thiourea; and mixtures thereof. Other secondary reducing agents may include cobalt (II) chloride, ferrous chloride, ferrous sulfate, hydrazine, hydroxylamine (depending on the choice of oxidizing agent), salts of a dithionite or sulfite anion, and mixtures thereof. Preferably, the reducing agent is an amine.

Suitable oxidizing agents will also be familiar to those skilled in the art, and include but are not limited to persulfuric acid and salts thereof, such as sodium, potassium, ammonium, cesium, and alkyl ammonium salts. Additional oxidizing agents include peroxides such as benzoyl peroxides, hydroperoxides such as cumyl hydroperoxide, t-butyl hydroperoxide, and amyl hydroperoxide, as well as salts of transition metals such as cobalt (III) chloride and ferric chloride, cerium (IV) sulfate, perboric acid and salts thereof, permanganic acid and salts thereof, perphosphoric acid and salts thereof, and mixtures thereof.

It may be desirable to use more than one oxidizing agent or more than one reducing agent. Small quantities of transition metal compounds may also be added to accelerate the rate of redox cure. In some embodiments it may be preferred to include a secondary ionic salt to enhance the stability of the polymerizable composition as described in U.S. Pat. Publication No. 2003/0195273 (Mitra et al.).

The reducing and oxidizing agents are present in amounts sufficient to permit an adequate free-radical reaction rate. This can be evaluated by combining all of the ingredients of the composition except for the optional filler, and observing whether or not a hardened mass is obtained.

Typically, the reducing agent, if used at all, is present in an amount of at least 0.01% by weight, and more typically at least 0.1% by weight, based on the total weight (including water) of the components of the composition. Typically, the reducing agent is present in an amount of no greater than 10% by weight, and more typically no greater than 5% by weight, based on the total weight (including water) of the components of the unfilled composition.

Typically, the oxidizing agent, if used at all, is present in an amount of at least 0.01% by weight, and more typically at least 0.10% by weight, based on the total weight (including water) of the components of the composition. Typically, the oxidizing agent is present in an amount of no greater than 10% by weight, and more typically no greater than 5% by weight, based on the total weight (including water) of the components of the unfilled composition.

The reducing or oxidizing agents can be microencapsulated as described in U.S. Pat. No. 5,154,762 (Mitra et al.). This will generally enhance shelf stability of the composition, and if necessary permit packaging the reducing and oxidizing agents together. For example, through appropriate selection of an encapsulant, the oxidizing and reducing agents can be combined with an acid-functional component and optional filler and kept in a storage-stable state. Likewise, through appropriate selection of a water-insoluble encapsulant, the reducing and oxidizing agents can be combined with an fluoro-aluminosilicate (FAS) glass and water and maintained in a storage-stable state.

A redox cure system can be combined with other cure systems, including photoinitiator systems or with a composition such as described U.S. Pat. No. 5,154,762 (Mitra et al.).

In another embodiment of the present disclosure, the initiator system comprises free radical-generating thermal initiators. Thermal initiators include organic peroxides (e.g., benzoyl peroxide), azo compounds, quinones, nitroso compounds, acyl halides, hydrazones, mercapto compounds, pyrylium compounds, imidazoles, chlorotriazines, benzoin, benzoin alkyl ethers, diketones, phenones, and mixtures thereof. Examples of suitable thermal initiators are VAZO 52, VAZO 64 and VAZO 67 azo compound thermal initiators, all available from DuPont. Preferred thermal initiators include benzoyl peroxide, dicumylperoxide, and andazobisisobutyronitrile (AIBN).

### Nanofiller

The hardenable compositions of the disclosure can be formulated with one or more nanofillers that impart desirable wear and aesthetic properties (e.g., tooth like color to mask the underlying metal). Suitable nanofillers include either acid reactive or non-acid reactive nanofillers and may include, but are not limited to silica; zirconia; oxides of titanium, aluminum, cerium, tin, yttrium, strontium, barium, lanthanum, zinc, ytterbium, bismuth, iron, and antimony; and combinations thereof. More typical nanofillers may include zirconia (ZrO₂); oxides of titanium (e.g., TiO₂), and oxides of yttrium (e.g., Y₂O₃); and other metal oxides with high refractive indices. In preferred embodiments, the nanofiller comprises an oxide of titanium. As used herein, “high refractive index” means a refractive index of typically at least 1.5, and more typically of at least 2.0. Titania and zirconia are particularly useful nanofillers, as they have very high refractive indices, and will require less weight of material than a lower refractive index material to match the refractive indices appropriately.

The nanofillers typically have an average particle size of at most 100 nanometers and more typically at most 50 nanometers. Such nanofillers typically have an average particle size of at least 2 nanometers, more typically at least 5 nanometers, and even more typically at least 10 nanometers. In some embodiments, the nanofiller is in the form of nanoclusters, typically at least 80 percent by weight nanoclusters. In other embodiments, the nanofiller is in the form of a combination of nanoparticles and nanoclusters. Often a portion of the surface of the nanofiller is silane treated or otherwise chemically treated to provide one or more desired physical properties. Additional suitable nanofillers are disclosed in U.S. Pat. No. 6,387,981 (Zhang et al.) and U.S. Pat. No. 6,572,693 (Wu et al.), U.S. Publication No. 2008/0293846 (Craig et al.), as well as International Publication Nos. WO 01/30305 (Zhang et al.), WO 01/30306 (Windisch et al.), WO 01/30307 (Zhang et al.), and WO 03/063804 (Wu et al.). Filler components described in these references include nanosized silica particles, nanosized metal oxide particles, and combinations thereof.

Typically, the nanofillers of the present disclosure are non-pyrogenic fillers, however pyrogenic fillers can be added as optional additives to the dental compositions.

The amount of nanofiller should be sufficient to provide a hardenable composition having desirable mixing and handling properties before hardening and good physical and optical properties after hardening. Typically, the nanofiller represents at least 0.1 wt-%, more typically at least 5 wt-% or 10 wt-%, and most typically at least 20 wt-% based on the total weight of the composition. Typically, the nanofiller represents at most 60 wt-%, more typically at most 50 wt-%, and most typically at most 40 wt-%, based on the total weight of the composition.

### Pigments & Other Fillers

The hardenable compositions of the present disclosure can further include pigments. A tooth-colored pigment can be achieved, for example, by using a mixture of titanium dioxide and iron oxide. The titanium dioxide and iron oxide pigments can be used in varying amounts depending on the shade of tooth enamel desired to be reproduced. For example, 15 wt-% to 55 wt-% titanium dioxide, and 0.01 wt-% to 4.5 wt-% iron oxide, based on the total weight of the hardenable composition, give a natural tooth enamel appearance to the coating. Additional pigments or colorants can be optionally added to the starting coating powders to color-match the polymeric coating to a desired tooth color.

In addition to the nanofiller and pigment components, the hardenable compositions of the present disclosure can also optionally include one or more other fillers. Such fillers may be selected from one or more of a wide variety of materials suitable for the use in dental and/or orthodontic compositions.

The other filler can be an inorganic material. It can also be a crosslinked organic material that is insoluble in the resin component of the composition, and is optionally filled with inorganic filler. The filler should in any event be nontoxic and suitable for use in the mouth. The filler can be radiopaque or radiolucent. The filler typically is substantially insoluble in water.

Examples of suitable inorganic fillers are naturally occurring or synthetic materials including, but not limited to: quartz; nitrides (e.g., silicon nitride); glasses derived from, for example, Zr, Sr, Ce, Sb, Sn, Ba, Zn, and Al; feldspar; borosilicate glass; kaolin; talc; titania; low Mohs hardness fillers such as those described in U.S. Pat. No. 4,695,251 (Randklev); and silica particles (e.g., submicron pyrogenic silicas such as those available under the trade designations AEROSIL, including “OX 50,” “130,” “150” and “200” silicas from Degussa AG, Hanau, Germany and CAB-O-SIL M5 and TS 720 silica from Cabot Corp., Tuscola, Ill.). Examples of suitable organic filler particles include filled or unfilled pulverized polycarbonates, polyepoxides, and the like.

Suitable non-acid-reactive filler particles are quartz, submicron silica, and non-vitreous microparticles of the type described in U.S. Pat. No. 4,503,169 (Randklev). Mixtures of these non-acid-reactive fillers are also contemplated, as well as combination fillers made from organic and inorganic materials.

The surface of the filler particles can also be treated with a coupling agent. Suitable coupling agents include gamma-methacryloxypropyltrimethoxysilane, gamma-mercaptopropyltriethoxysilane, gamma-aminopropyltrimethoxysilane, and the like. Examples of useful silane coupling agents are those available from Crompton Corporation, Naugatuck, Conn., as SILQUEST A-174 and SILQUEST A-1230. For some embodiments of the present disclosure that include other fillers the compositions may include at least 1% by weight, more preferably at least 2% by weight, and most preferably at least 5% by weight other filler, based on the total weight of the composition. For such embodiments, compositions of the present disclosure preferably include at most 75% by weight, more preferably at most 65% by weight, and even more preferably at most 55% by weight other filler, based on the total weight of the composition.

When the polymer composition contains an ethylenically unsaturated compound and at least one filler, it is generally present in an amount of at least 15% by weight, more typically at least 25% by weight, and most typically at least 35% by weight ethylenically unsaturated compounds, based on the total weight of the filled composition. The compositions of the present disclosure typically include at most 95% by weight, more typically at most 90% by weight, and most typically at most 80% by weight ethylenically unsaturated compounds, based on the total weight of the filled composition.

When the composition contains an ethylenically unsaturated compound with acid functionality, it is generally present in an amount of at least 1% by weight, more typically at least 3% by weight, and most typically at least 5% by weight ethylenically unsaturated compounds with acid functionality, based on the total weight of the unfilled composition. The compositions of the present disclosure typically include at most 80% by weight, more typically at most 70% by weight, and most typically at most 60% by weight ethylenically unsaturated compounds with acid functionality, based on the total weight of the unfilled composition.

### Other Additives

Optionally, compositions of the present disclosure can contain solvents (e.g., alcohols (e.g., propanol, ethanol), ketones (e.g., acetone, methyl ethyl ketone), esters (e.g., ethyl acetate), other nonaqueous solvents (e.g., dimethylformamide, dimethylacetamide, dimethylsulfoxide, 1-methyl-2-pyrrolidinone)), or mixtures thereof.

Compositions of the present disclosure may further include core-shell polymer compounds. A core-shell compound includes a soft core comprising a rubber or elastomeric polymer surrounded by a shell comprising a more rigid polymer. Such compounds may reduce the shrinkage of the composition on polymerization. Exemplary core-shell polymer compounds are discussed in U.S. Publication No. 2005/0124762. (Cohen et al.).

If desired, the compositions of the disclosure may contain additives such as indicators, dyes (including photobleachable dyes), inhibitors, accelerators, viscosity modifiers, wetting agents, antioxidants, tartaric acid, chelating agents, buffering agents, stabilizers, diluents, and other similar ingredients that will be apparent to those skilled in the art. Surfactants, for example, nonionic surfactants, cationic surfactants, anionic surfactants, and combinations thereof, may optionally be used in the compositions. Useful surfactants include non-polymerizable and polymerizable surfactants. Additionally, medicaments or other therapeutic substances can be optionally added to the hardenable compositions. Examples include, but are not limited to, fluoride sources, whitening agents, anticaries agents (e.g., xylitol), remineralizing agents (e.g., calcium phosphate compounds and other calcium sources and phosphate sources), enzymes, breath fresheners, anesthetics, clotting agents, acid neutralizers, chemotherapeutic agents, immune response modifiers, thixotropes, polyols, anti-inflammatory agents, antimicrobial agents, antifungal agents, agents for treating xerostomia, desensitizers, and the like, of the type often used in dental compositions.

Combination of any of the above additives may also be employed. The selection and amount of any one such additive can be selected by one of skill in the art to accomplish the desired result without undue experimentation.

### Exemplary Composition of the Polymeric Layer Disposed on the Ceramic Material

Suitable hardenable compositions for use in the polymeric layer disposed on the ceramic material (i.e., the basecoat) typically include a polymerizable component, a photoinitiator, a thermal initiator, a nanofiller, a pigment, and a filler. Particularly suitable polymerizable components for use in the basecoat include UDMA, phenoxyethylmethacrylate, and combinations thereof. For basecoat hardenable compositions of the present disclosure that include fillers (nanofillers & other fillers) the compositions may include at least 1% by weight, more preferably at least 2% by weight, and most preferably at least 5% by weight filler, based on the total weight of the composition. For such embodiments, compositions of the present disclosure preferably include at most 75% by weight, more preferably at most 65% by weight, and even more preferably at most 55% by weight filler, based on the total weight of the composition.

### Preparation Of Polymer Compositions

The polymer compositions useful in the ceramic/polymer hybrid coating of the present disclosure can be prepared by combining all the various components using conventional mixing techniques. The resulting composition may optionally contain fillers, solvents, water, and other additives as described herein. Typically, photopolymerizable compositions of the disclosure are prepared by simply admixing, under “safe light” conditions, the components of the inventive compositions. Suitable inert solvents may be employed if desired when affecting this mixture. Any solvent may be used which does not react appreciably with the components of the inventive compositions. Examples of suitable solvents include acetone, dichloromethane, isopropyl alcohol, ethanol, and butanone.

The amounts and types of each ingredient in the polymer compositions may be adjusted to provide the desired physical and handling properties before and after polymerization. For example, the polymerization rate, polymerization stability, fluidity, compressive strength, tensile strength and durability of the dental material typically are adjusted in part by altering the types and amounts of polymerization initiator(s) and the loading and particle size distribution of filler(s). Such adjustments typically are carried out empirically based on previous experience with dental materials.

The components of the composition can be included in a kit, where the contents of the composition are packaged to allow for storage of the components until they are needed.

### Coating the Dental Article

Prior to depositing the ceramic/polymer hybrid coating, the target surface(s) (i.e., the portion of the article to be coated) of the dental article may be primed (e.g., abraded, etched, particles deposited) to enhance the bond between the coating and the metal substrate surface. In one embodiment, the target surfaces may be first sandblasted as known in the art by, for example, the method shown in U.S. Pat. No. 5,024,711 to Gasser et al. The target surfaces may be microblasted with an aluminum oxide sand, such as ROCATEC Pre, available from 3M ESPE. In some embodiments, the target surface may be subsequently treated with a silica-modified aluminum oxide, such as ROCATEC Plus, also available from 3M ESPE. Alternatively, the outer surface may be treated with ROCATEC Plus or other silica-modified aluminum oxide without prior treatment with ROCATEC Pre.

In another embodiment, the target surface of the dental article is primed or otherwise modified by etching with a strong acid such as hydrochloric acid. Additional useful etchants include nitric acids, hydrofluoric acids, ferric chlorides, sodium hydroxides, and combinations thereof. Although not wishing to be bound by theory, the roughening (i.e., priming) of the target surface by acid-etch or sandblast creates greater surface area and may strengthen the ceramic/polymer hybrid coating bond to the chosen metal substrate.

The target surface may also be coated with a diamond-like glass (DLG), such as those described in U.S. Pat. No. 6,696,157 to David et al, as part of the priming process. DLG is an amorphous carbon system including a substantial quantity of silicon and oxygen that exhibits diamond-like properties. DLG may be deposited onto at least a portion of the target surface by plasma deposition or other techniques known to those having skill in the art.

Once the target surface of the dental article has been primed, the ceramic material may be deposited according to methods well known in the art, including, but not limited to, plasma spraying (i.e., thermal spraying), and powder coating followed by sintering. The ceramic material is directly bonded, by e.g., an intimate chemical or mechanical interaction, to the target surface. In certain preferred embodiments, the ceramic layer is made to include a smooth surface by, for example, using higher temperatures & smaller colloidal particles in the plasma spray. In one embodiment, the ceramic layer is deposited after priming and silanization and/or treatment with Zirconate as described below. In embodiments wherein a discontinuous ceramic layer is contemplated, the pattern (e.g., alternating gaps & ceramic deposits) may be created during the ceramic application (by e.g. lithography, masking) or after application of the ceramic layer (by e.g., laser ablation). For example, a curable resin can be applied in a grid, or waffle, pattern by a printing process. A layer of ceramic deposited on top of this pre-applied pattern, by thermal spraying, sputtering, or a similar process, will conform to the pre-existing pattern, creating a similar patterned structure on the surface of the dental article.

Alternatively, a thermally-sprayed layer of ceramic can be applied through a metal mask containing apertures in a pattern to be replicated on the underlying substrate. The mask may be disposed between the plasma spray mechanism and the dental article. The ceramic material may then be sprayed through the apertures, leaving portions of the outer surface uncoated and accordingly forming a discontinuous ceramic layer. Only that portion of the spray passing through the mask will actually deposit on the surface of the dental article.

Additionally or alternatively, the pattern or porosity may be created by subsequent laser ablation or sandblasting of targeted portions of the deposited ceramic layer. The laser used for converting (e.g., perforating or cutting) the ceramic layer article may be any suitable conventional laser. While many laser types may be suitable for the ablating of the ceramic coated articles described herein, high density gain media lasers such as solid state lasers, are particularly preferred. High density gain media lasers can span the infrared to the ultraviolet portion of the light spectrum, and also offer high peak power and high continuous power. Theses lasers can be composed of two types of gain media: insulators (e.g., Nd:YAG to Ti:Sapphire) and semiconductor (e.g., GaAs to Lead Salt). One potentially preferred example of this type of laser is Nd:YVO₄ or neodymium-doped yttrium vanadate laser, and its shorter wavelength harmonics.

An additional bonding layer may be deposited on the ceramic layer and/or the surface of the dental article once the ceramic material has been deposited on the target surface. The ceramic coated dental article may undergo silanization by, for example, spray or bath after the sandblast or acid-etch abrasion procedure. Exemplary useful silanes include, but are not limited to, 3M ESPE Sil, available from 3M ESPE and methacryloxypropyltrimethoxy silane, available under the tradename GENIOSIL GF-31, from Wacker Chemical, Adrian, Mich. Alternatively or additionally, the primed dental article may be exposed (e.g., by spray or bath) to Zirconate coupling agents available from Kenrich Petrochemicals, Bayonne, N.J.

If a hardenable composition includes phophorylated monomers, it may be unnecessary to include a bonding layer on the target surface of the dental article/ceramic layer after priming.

The one or more layers of hardenable composition can be applied using conventional techniques, including, but not limited to, dip coating, spray coating, spin coating, brush coating, and lithographic printing. In certain embodiments, the hardenable composition is deposited on the ceramic layer prior to full or partial curing.

Thickness gradients and occlusal coatings may be created, for example, by directional spraying only the targeted portion of the crown with the ceramic material and/or the hardenable composition so that substantially none of the coating is applied below the height of contour.

In embodiments wherein the hardenable composition includes a photoinitiator, a curing light, such as a VISILUX Model 2500 blue light gun (3M Co., St. Paul, Minn.) or a ELIPAR Freelight 2 LED CuringLight (available from 3M ESPE Dental Products, St. Paul, Minn.) is generally required to irradiate the hardenable compositions and initiate hardening (i.e., polymerization). Alternatively, an irradiating chamber may be used, such as a VISIO Beta Vario Light Curing Unit (available from 3M ESPE Dental Products, St. Paul, Minn.).

In embodiments wherein the hardenable composition comprises a thermal initiator, heat may be used to initiate the hardening of free radically active groups. Examples of heat sources suitable for curing include inductive, convective, and radiant heat sources. Thermal sources should be capable of generating temperatures of at least 40° C. and at most 150° C. under normal conditions or at elevated pressure.

In certain embodiments wherein the hardenable composition comprises a photoinitiator and a thermal initiator, the curing process includes both irradiation and exposure to heat.

As noted above, the ceramic/polymer hybrid coating can provide desirable aesthetic properties, such as close approximation of tooth color. The following parameters form the basis of the color determination of the coated dental article: Opacity value O: Measure of the transparency (0% is completely transparent, 100% is opaque), L*-value: Brightness (100: complete reflection; 0; no reflection); a*-value: Red-green shift (+a: red; −a: green); b*-value: yellow-blue shift (+b: yellow; −b: blue).

The L*-value of a coated dental article is preferably greater than 60, more preferably greater than 75, and even more preferably greater than 80. The ceramic/polymer hybrid coating may also be tailored to the shades on the VITA shade guide. The a* value of a coated dental article is within the range of −3 to 13. The b* value of a coated dental article is within the range of 10 to 35.

The ceramic/polymer hybrid coating can provide desirable flexibility. One method of determining flexibility includes the bending of a 150 micron thick metal coupon around a mandrel. The metal coupon is preferably the same metal used on the outer surface of the dental article and includes a deposited ceramic/polymer hybrid coating. Preferably, a coated coupon can bend 180 degrees around an 8 millimeter mandrel without cracking of the coating. More preferably, a coated coupon can bend around a 4 millimeter mandrel, and even more preferably a 2 millimeter mandrel without cracking of the coating.

In another embodiment of the disclosure, a crown or a plurality of crowns (potentially of varying sizes) may be provided in a kit with the components of the ceramic/polymer hybrid coating. The crown(s) may preferably be provided in the kit pre-primed (i.e., the surface has been roughened according to techniques described below). The kit may further include ceramic material and one or more hardenable dental compositions. Such a kit may allow a practitioner to tailor the particular location and aesthetics of the coating on the crown. The kit may also include other components including, but not limited to, cements, brushes, and other tools to apply the coatings.

### Illustrative Embodiments

1. A method for coating a dental article comprising:

providing a body comprising a metal substrate; priming at least a portion of a surface of the body; depositing a ceramic material on at least a portion of a surface of the body, wherein said depositing forms a ceramic layer bonded directly to the surface; and depositing at least one hardenable composition comprising a polymerizable component on at least a portion of the ceramic layer, wherein depositing at least one hardenable composition forms a polymeric layer.
2. The method of embodiment 1, wherein priming at least a portion of a surface comprises: depositing a layer of diamond-like glass on at least a portion of the surface.
3. The method of embodiment 1, wherein priming a surface comprises:

exposing at least a portion of the surface to a strong acid or sandblasting at least a portion of the surface.
4. The method of any one of embodiments 1 to 3, further comprising applying a bonding layer to at least a portion of the outer surface, wherein the bonding layer is selected from the group consisting of: silane and zirconate.
5. The method of embodiment 4, wherein the bonding layer is applied after depositing the ceramic material.
6. The method of any of the previous embodiments, wherein depositing the ceramic layer comprises creating a continuous ceramic layer over at least a portion of the surface.
7. The method of any of the previous embodiments, wherein the dental article is a stainless steel crown having a height of contour and a surface for contact with the opposing dentition, and wherein the ceramic material is deposited on the outer surface of the crown substantially above the height of contour.
8. The method of any of the previous embodiments, further comprising ablating at least a portion of the ceramic layer to form a discontinuous ceramic layer.
9. The method of embodiment 8, wherein the medical article is a stainless steel crown having a height of contour and wherein ablating at least a portion of the ceramic layer comprises ablating the ceramic layer on the outer surface above the height of contour.
10. The method of embodiment 1, further comprising sandblasting at least a portion of the ceramic layer to form a discontinuous ceramic layer.
11. The method of any one of embodiments 1-7, wherein depositing a ceramic material comprises lithographic printing the ceramic material to form a discontinuous ceramic layer.
12. The method of embodiments 1-7, wherein depositing the ceramic layer comprises

providing a mask comprising apertures;

providing a spray mechanism adapted to deposit a ceramic material on a target surface;

disposing the mask between the spray mechanism and the target surface;

propelling the ceramic material through said apertures and onto the target surface, wherein the ceramic layer comprises a discontinuous ceramic layer.
13. The method of any one of embodiments 1-3 and 5-12, wherein the ceramic material is selected from the group consisting essentially of: alumina, zirconia, yttria, yttria-stabilized zirconia, porcelain, and combinations thereof.
14. The method of any one of embodiments 1-3 and 5-12, wherein the polymeric component comprises at least one (meth)acrylate monomer.
15. The method of any one of embodiments 1-3 and 5-12, wherein the polymerizable component is selected from the group consisting of phenoxoyethyl methacrylate, urethane dimethacrylate, polyethylene glycol methacrylate, polypropylene glycol methacrylate, triethyleneglycol dimethacrylate, the diglycidyl methacrylate of bisphenol A, and combinations thereof.
16. The method of any one of embodiments 1-3 and 5-12, wherein the polymerizable component is a compound according to the formula:

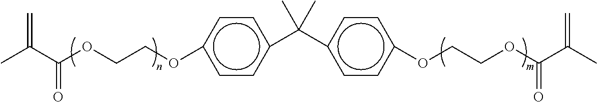

wherein m+n is between 5 and 8.
17. The method of any of the previous embodiments, wherein at least one hardenable composition comprises an initiator system, the initiator system comprising a photoinitiator and a thermal initiator.
18. The method of any of the previous embodiments, wherein at least one hardenable composition comprises a filler, wherein the filler is present at no greater than 20 weight percent by weight of the composition.
19. The method of embodiment 18, wherein the filler comprises a fumed silica particle.
20. The method of any of the previous embodiments, wherein at least one hardenable composition further comprises a pigment selected from the group consisting of titanium dioxide, iron oxide, and combinations thereof.
21. The method of embodiment 18, wherein the pigment is present at a weight of no greater than 55% by weight of the polymer.
22. The method of any of the previous embodiments embodiment, further comprising curing at least one hardenable composition on the surface of the dental article.
23. The method of embodiment 1-7 and 13-21, wherein depositing the ceramic material comprises plasma spraying the ceramic material on the surface of the body.
24. The method of embodiment 23, wherein plasmas spraying the ceramic material further comprises directional pattern coating the surface to form a discontinuous ceramic layer.
25. The method of any of the previous embodiments, wherein a hybrid coating layer comprises the ceramic layer and the polymeric layer, and wherein the hybrid coating layer has a thickness of no greater than 250 microns above the height of contour.
26. The method of embodiment 4, wherein the thickness of the ceramic layer at a cervical margin of the crown is less than the thickness of the ceramic layer on the occlusal surface.
27. The method of any of the previous embodiments, wherein the hardenable composition further comprises flexible monomers, multimethacyrlate oligomers, and combinations thereof.
28. The method of embodiment 1, further comprising

irradiating at least a portion of the surface; and

exposing at least a portion of the surface to heat.
29. A dental article comprising:

a first layer of material disposed on and bonded directly to at least a portion of a surface of the dental article, wherein the first layer comprises a ceramic material;

a second layer of material disposed on at least a portion of the ceramic material, wherein the second layer comprises at least one hardened composition comprising a polymerizable component.
30. The dental article of embodiment 29, wherein the dental article is a crown having a surface for contact with the opposing dentition and a height of contour proximate said contact surface; and wherein the ceramic material is disposed on at least a portion of outer surface substantially above the height of contour.
31. The dental article of any one of embodiment 29-30, wherein the ceramic material is selected from a group consisting of alumina, zirconia, yttria, yttria-stabilized zirconia, porcelain, and combinations thereof.
32. The dental article of embodiment 29, wherein the first layer is a discontinuous ceramic layer.
33. The dental article of embodiment 32, wherein the discontinuous ceramic layer extends over at least a portion of the outer surface above the height of contour.
34. The dental article of any of the previous embodiments, wherein the first layer comprises a ceramic thickness, and wherein the ceramic thickness is no greater than 151 microns.
35. The dental article of any one of embodiments30-34, wherein the dental article further comprises a gingival-labial outer edge region and a gingival-lingual outer edge region, and wherein neither the first nor the second layer is disposed on a portion of either the gingival-labial outer edge region or the gingival-lingual outer edge region.
36. The dental article any one of the prior embodiments, wherein at least one polymerizable component further comprises an ethlenically unsaturated compound.
37. The article of any one of the previous embodiments, wherein the polymerizable component is selected from the group consisting of phenoxoyethyl methacrylate, urethane dimethacrylate, polyethylene glycol methacrylate, polypropylene glycol methacrylate, triethyleneglycol dimethacrylate, the diglycidyl methacrylate of bisphenol A, and combinations thereof.
38. The article of any one of the previous embodiments, wherein the polymerizable component is a compound according to the formula:

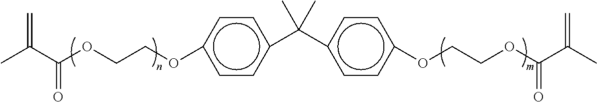

wherein m+n is between 5 and 8.
39. The article of any one of the previous embodiments, wherein the polymerizable component is selected from the group consisting of phenoxylethylmethacrylate, urethane dimethacrylate, and combinations thereof.
40. The article of any one of the previous embodiments, wherein the polymerizable component further comprises a core-shell polymer compound.
41. The article of any of the previous embodiments wherein at least one hardened composition comprises an initiator system, said initiator system comprising a photoiniator and a thermal initiator.
42. The article of any of the previous embodiments, wherein at least one hardened composition comprises a filler, wherein the filler is present at no greater than 20 weight percent by weight of the composition.
43. The article of any of the previous embodiments, wherein at least one hardened composition further comprises a pigment selected from the group consisting of titanium dioxide, iron oxide, and combinations thereof.
44. The article of embodiment 43, wherein the pigment is present at a weight of no greater than 55% by weight of the polymer.
45. The article of any one of the previous embodiments, wherein at least one hardened composition further comprises flexible monomers, multimethacyrlate oligomers, and combinations thereof.
46. The article of any one of the previous embodiments, wherein a hybrid coating layer comprises the ceramic layer and the polymeric layer, and wherein the hybrid coating layer has a thickness of no greater than 250 microns.
47. The article of embodiment 46, wherein the hybrid coating layer comprises a thickness gradient.
48. The article of any one of the previous embodiments, further comprising a diamond-like glass layer deposited on at least a portion of the outer surface.
49. The article of any one of the previous embodiments, further comprising a bonding layer deposited on at least a portion of the outer surface, wherein the bonding layer comprises a component selected from the group consisting of silane and zirconate.
50. A kit comprising:

At least one crown;

at least one hardenable composition comprising a polymerizable component, an initiator system, a pigment, and filler;

at least one of a cement, a brush, and instructions for application of the ceramic material and at least one hardenable dental composition.
51. The kit of embodiment 50, wherein crown further comprises a diamond-like glass layer on at least a portion of the outer surface.
52. The kit of embodiment 50 or 51, wherein the ceramic composition comprises a ceramic chosen from the group consisting of alumina, zirconia, yttria, yttria-stabilized zirconia, porcelain, and combinations thereof.
53. The kit of embodiments 51-52, wherein the polymerizable component is selected from the group consisting of phenoxoyethyl methacrylate, urethane dimethacrylate, polyethylene glycol methacrylate, polypropylene glycol methacrylate, triethyleneglycol dimethacrylate, the diglycidyl methacrylate of bisphenol A, and combinations thereof.
54. The kit of embodiments 51-53, wherein the bonding layer is selected from the group consisting of silane and zirconate.

Objects and advantages of this invention are further illustrated by the following examples, but the particular materials and amounts thereof recited in these examples, as well as other conditions and details, should not be construed to unduly limit this invention. Unless otherwise indicated, all parts and percentages are by weight.

### EXAMPLES

TABLE 1

| Abbreviation | Chemical description (supplier, location) |
|---|---|
| UDMA | Diurethane Dimethacrylate (Rohm Tech, |
| | Inc. (Malden, MA) |
| SR340 | 2-phenoxyethyl methacrylate (Sartomer |
| | Co., Inc., Exton, PA) |
| GF-31 | 3-methacryloxypropyltrimethoxy silane |
| | (Wacker Chemie, Germany) |
| Dibutyl tin dilaurate | Sigma-Aldrich |
| TiO2, R960 | Titanium dioxide, R960 (Dupont, |
| | Wilmington, DE) |
| TiO2, 2160 | Titanium dioxide, 2160 (Kronos |
| | Worldwide, Cranbury, NJ) |
| TS-720 | Surface treated fumed silica, (Cabot, |
| | Boston, MA) |
| Aerosil R972 | Surface treated fumed silica (Degussa, |
| | Germany) |
| PolyTHF diol | Poly tetrahydrofuran diol T2000, (Invista, |
| | Wichita, KS) |
| Alumina for plasma spray | Alumina suspension, (Northwest Mettech, |
| | Vancouver, BC, Canada) |
| Irgacure 819 | Bis(2,4,6- |
| | Trimethylbenzoyl)phenylphosphine oxide |
| | (Ciba Inc., Tarrytown, NY) |
| CC42 | Variquat (EMCOL) CC42 cationic |
| | surfactant (Evonik Goldschmidt Corp., |
| | Hopewell VA) |
| CC59 | Variquat (EMCOL) CC59 alkoxylated |
| | ammonium phosphate cationic surfactant, |
| | (Evonik Goldschmidt) |
| Yttria stabilized Zirconia for | Yttria stabilized zirconia suspension, |
| plasma spray | (Northwest Mettech) |
| IEM | 3-isocyanatoethyl methacrylate (Sigma- |
| | Aldrich, St. Louis, MO) |
| DCP | Dicumyl peroxide (Pfaltz & Bauer, |
| | Waterbury, CT) |
| BYK 2155 | Wetting and dispersing additive (BYK |
| | USA Inc., Wallingford, CT) |
| Silica/zirconia cluster | Refers to silane-treated zirconia/silica |
| | nanocluster filler prepared essentially as |
| | described in U.S. Pat. No. 6,730,156 |
| | (Preparatory Example A (line 51-64) and |
| | Example B (column 25 line 65 through |
| | column 26 line 40). |
| Dibenzoyl peroxide | Sigma Aldrich, St. Louis, MO |
| Z250 | Dental Composite (3M, St. Paul, MN) |

### Test Methods

### Flexibility

Samples of coating compositions were applied to sheets of 150 μm thick stainless steel to achieve thicknesses of approximately 25, 50 and 75 μm. The resulting samples were bent through 180° around a 2 mm diameter mandrel using finger pressure. During the bending process, the angle was measured for which a crack first appeared for each thickness of each example composition. A material is considered to pass if it is successfully bent through 180° without cracking A minimum of 3 replicates were carried out for each thickness and composition, and the measured values were averaged.

### Two-Body Wear (“Artificial Mouth” Model)

This test was designed to utilize a Servo-Hydraulic Model of the “Artificial Mouth” (University of Minnesota Dental Research Center for Biomaterials and Biomechanics; MTS Corporation, Minneapolis, Minn.) to measure the coating wear of various powder-coated metal dental crowns. The “Artificial Mouth” Model was designed to simulate chewing action and is described in R. Delong and W. H. Douglas, “The Development of an Artificial Oral Environment of Testing of Restoratives,” J. Dental Research, No. 62, Pages 32-36, 1983. The “Artificial Mouth” Model was configured such that the test coated crown sample (maxillary second molar) was opposed by a cusp from an extracted human third molar. During the test run, the antagonist slid against the labial surface of the coated crown at 16 Newtons force and at 4 cycles per second. The test was stopped after every 5000 cycles and the point of contact on the coated crown (lingual surface) was photographed with a high-resolution digital camera. The test was then continued for a total of 25000 cycles. The resulting digital photographs were closely scrutinized and rated on the basis of the features of the wear area and on the degree of penetration of the coating (that is clearly visible due to the underlying exposed metal crown). The photograph assessments were rated according to the following scale:
1. Extensive visible metal exposure
2. Medium visible metal exposure
3. Minimum visible metal exposure
4. Minimum visible coating surface wear (no visible metal exposed)
5. No visual wear

### Mixed Two-Body/Three-Body Wear (“Artificial Mouth” Model)

In order to test coatings in a more aggressive fashion than that obtained with the two-body wear test, the two-body wear test described above was modified as follows. In place of the 37° C. water typically used in a two-body wear test as a medium around the chewing surfaces, an artificial food bolus was added to the mixture. The composition of this food bolus is prepared as described in P. Pallav, C. L. Davidson, and A. J. DeGee, J Pros Dent 59 (1988) (4), pp. 426-429. This artificial food bolus was continuously agitated throughout the test to ensure uniformity. Coating performance was assessed by photographic evaluation at the midpoint (˜13000 cycles) and end (25000 cycles) of the test as described for the two-body wear test.

### Three Body Wear

In order to test the wear resistance of certain compositions, samples were constructed and tested according to the ACTA method described by P. Pallav, C. L. Davidson, and A. J. DeGee in J Pros Dent 59 (1988) (4), pp. 426-429, with minor modifications (ACTA wear system, based on a Perthometer profiler and ACTA Wear software version 3). Segments including certain compositions were attached to a brass wear wheel, and subjected to the 3-body wear process for 200000 cycles. Profiles of the wear wheel segments were taken at 40000 cycle intervals, and the slope of the resulting loss of material versus number of cycles was calculated and compared to that of a standard dental composite, 3M-ESPE Z250, in the same wear wheel.

### Trimming and Crimping

Crowns were evaluated by a practicing pediatric dentist for trimming and crimping. Trimming was carried out using a diamond burr, removing up to 2 mm of material along the interproximal marginal edge. The trimmed region was subsequently crimped using crimping pliers (No. 800-421, 3M Company) to a typical extent. Visual observation of any coating damage, e.g., cracking, chipping, flaking, delamination, was made and reported following the crimping and trimming of each coated crown.

### Examples

### Preparatory Example

### PolyTHF Dimethacrylate

To a jar containing ˜78 g of polyTHF diol being stirred at 50° C. was added ˜0.2 mL of dibutyl tin dilaurate. After stirring for 5 minutes, ˜11 mL of IEM was added dropwise over 5 minutes. The resulting mixture was stirred for 24 h at ˜50° C., then cooled to room temperature. Conversion of the isocyanate was confirmed by IR spectroscopy.

### Preparatory Example

### TiO2, Surface Treated

To a mixture of approximately 4.4 parts of GF-31 with 4.4 parts of methanol was added a mixture of approximately 1.5 parts deionized water and 1.5 parts glacial acetic acid, adjusted to a pH of ˜2. This solution was added to a preblended mixture of TiO2 (96 parts) and Aerosil R-972 (1.7 parts) and stirred for approximately 10 minutes. The resulting surface treated filler was placed in an oven and dried above 100° C. for ˜4 h.

TABLE 2
Coating compositions (parts by weight)

| | | Coating | Coating | Coating | Coating |
|---|---|---|---|---|---|
| Component | Coating 1 | 2 | 3 | 4 | 5 |
| UDMA | 29.0 | 25.8 | 88.2 | 23.2 | 48.5 |
| SR340 | 29.0 | 25.8 | | 23.2 | 2.5 |
| PolyTHF diol | | 5.7 | | | |
| diacrylate | | | | | |
| PolyTHF di-IEM | | | | 11.6 | 0 |
| Dibenzoyl peroxide | | | | 0.3 | 0.3 |
| Irgacure 819 | 1.2 | 1.2 | 1.8 | 0.2 | 0.3 |
| DCP | | 0.3 | | | |
| BYK 2155 | | 0.4 | | 0.4 | 1.4 |
| CC59 | 0.12 | 0.2 | | 0.2 | 0 |
| CC42 | 1.2 | | | | |
| TiO2, 2160 | 39.0 | | 5.0 | | |
| TiO2, R960 | | 40 | | 40 | 5.0 |
| TS-720 | 0.5 | 0.5 | 5.0 | 1.0 | 2.0 |
| Silica/zirconia cluster | | | | | 40 |

These components were preheated at 80° C. in an oven and were mixed in a Speedmixer until uniformly dispersed. First, the resin components were mixed, then the remaining pigments and/or fillers and surfactants were added and Speedmixed to a uniform dispersion.

### Example 1

A stainless steel primary molar crown was sandblasted with 60 grit alumina and coated with approximately 100 μm of alumina on the occlusal surface above the height of contour by plasma spray deposition using an Axial III plasma torch (Northwest Mettech, Vancouver, BC, Canada). The ceramic-coated crown was subsequently surface-treated with GF-31 in 50/50 ethanol/water acidified with glacial acetic acid to a pH of ˜4 for 3 min. at room temperature, then rinsed in absolute ethanol. The treated crowns were then baked in a 120 deg. C oven for 20 min. The resulting treated crown was sprayed with a Sono-Tek Ultrasonic Spray Head (Sono-Tek Corp, Milton, N.Y.) with a 75 wt % solution of coating 1 in acetone. The thickness of this coating was targeted to be ˜0.1 mm. The coating was cured by exposure to an array of 455 nm LEDs under a CO2 atmosphere, and postcured in an oven for 1 h at 140° C. under nitrogen. The result was a thin smooth white coating with no steel visible with the anatomical details of the original crown intact.

### Example 2

A stainless steel primary molar crown was sandblasted and coated with approximately 100 μm of yttria-stabilized zirconia on the occlusal surface by plasma spray deposition using an Axial III plasma torch (Northwest Mettech, Vancouver, BC, Canada). The ceramic-coated crown was subsequently surface-treated with GF-31 in 50/50 ethanol/water acidified with glacial acetic acid to a pH of ˜4 for 3 min. at room temperature, then rinsed in absolute ethanol. The treated crowns were then baked in a 120 deg. C oven for 20 min. The silane-treated crown was coated with a layer of a 64% dilution of coating 2 in isopropanol, with a targeted thickness after drying of ˜40 μm. The initial coating was tack-cured under exposure to a dental curing light for 10 s in air (XL2500, 3M-ESPE).

A second layer of coating 3, 50% dilution with isopropanol) was applied to the occlusal surface of the crown with a target thickness after drying of 100 μm. After the second coating step, the crown was cured by exposure to an array of 455 nm LEDs under a CO2 atmosphere, and postcured in an oven for 1 h at 140° C. under nitrogen. The result was a thin smooth white coating with no steel visible with the anatomical details of the original crown intact.

### Example 3 & 4

Coating compositions 4 and 5 were applied to sheets of 150 μm thick stainless steel by spraying a 50 wt % solution of the coating in acetone with a Sono-Tek ultrasonic sprayhead to achieve thicknesses of approximately 25, 50 and 75 μm. The stainless steel had previously been prepared by sandblasting with Rocatec Plus sandblasting media (3M-ESPE), silane-treated with GF-31 (2 wt % in a 1:1 solution of ethanol and water, pH adjusted to about 4 using glacial acetic acid), and baked at 80 deg. C for 20 minutes. The sprayed coatings were cured by exposure to an array of 455 nm LEDs in a nitrogen atmosphere, followed by thermal curing at 110° C. in a nitrogen atmosphere for 2 h.

### Examples 5 & 6

Samples of coatings 4 and 5 were applied to brass wear wheel segments by spraying a 50 wt % solution of the coating in acetone with a Sono-Tek ultrasonic sprayhead, with a resulting coating thickness of between 250 and 300 μm. The resulting samples were cured by light and thermal exposure under nitrogen atmosphere as described previously.

### Comparative Example 1

A coated stainless steel crown was prepared as described in U.S. Pat. No. 7,008,229, using a coating similar to Powder II (Column 9).

### Comparative Example 2

A commercially available veneered stainless steel crown (NuSmile).

### Comparative Example 3

Preparation of the Z250 comparative composite was pressed out into an approximately 250 um thick sheet and transferred to a wear wheel segment that had been prepared by sandblasting, silane treating, and treating with Adper Singlebond Plus (3M ESPE) per manufacturer's instructions.

### Test Results

Trimming and crimping

A coated crown of Example 1 was trimmed and crimped. Little to no evidence of edge fracture was observable to the naked eye after this evaluation.

A coated crown of Example 2 was trimmed and crimped. Little to no evidence of edge fracture was observable to the naked eye after this evaluation.

A crown of Comparative Example 1 was evaluated. Evidence of chipping and delamination was clearly visible to the naked eye along the crimped, trimmed edge of the crown.

A crown of Comparative Example 2 was evaluated. Crimping was attempted along the coated surface using festooning pliers (3M-ESPE). Due to the thickness and modulus of the esthetic coating, the marginal edge of the crown could not be crimped using reasonable force by the dentist.

TABLE 3
Crimping and Trimming Observations of Coated Crowns

| Coated Crown | Crimping | Trimming |
|---|---|---|
| Example | Observations | Observations |
| 1 | OK | OK |
| 2 | OK | OK |
| CE-1 | Chipping | Delamination |
| CE-2 | Not Possible | Not Possible |

### Two-Body/Three-Body Wear

A coated crown of Example 1 was prepared and wear tested. The crown's appearance was evaluated at approximately 13000 cycles and 25000 cycles. At the end of 25000 cycles, no steel was exposed in the wear facet.

### Two Body Wear

A coated crown of Example 1 was prepared and wear tested. The crown's appearance was evaluated every 5000 cycles to 25000 cycles. At the end of 25000 cycles, no steel was exposed in the wear facet.

A coated crown of Example 2 was prepared and wear tested. The crown's appearance was evaluated every 5000 cycles to 25000 cycles. At the end of 25000 cycles, no steel was exposed in the wear facet.

A coated crown of Comparative Example 1 was prepared and wear tested. After 5000 cycles, the underlying steel was exposed in the wear facet. The exposed steel area continued to grow through the wear cycle to 25000 cycles.

TABLE 4
Two-Body Wear Results of Polymer Coated Metal Crowns

| Coated | | | | | | |
|---|---|---|---|---|---|---|
| Crown | | 5000 | 10,000 | 15,000 | 20,000 | 25,000 |
| Tested | Initial | cycles | cycles | cycles | cycles | cycles |
| 1 | 5 | 4 | 4 | 4 | 4 | 4 |
| 2 | 5 | 4 | 4 | 4 | 4 | 4 |
| CE-1 | 5 | 3 | 3 | 2 | 2 | 2 |

### Flexibility

Three replicates of Example 3 were prepared and tested for flexibility. Each sample successfully bent around the 2 mm mandrel 180° without cracking

Three replicates of Example 4 were prepared and tested for flexibility. Each sample thickness cracked prior to reaching 180° around the 2 mm mandrel.

TABLE 5
Bend Testing Results

Coating Thickness

| Example # | 25 μm | 50 μm | 75 μm |
|---|---|---|---|
| 3 | 180° - pass | 180° - pass | 180° - pass |
| 4 | 95° - fail | 50° - fail | 45° - fail |

Three Body Wear

Two coated brass wheel segments of Comparative Example 3 were prepared and wear tested. The slope of the resulting loss of material versus number of cycles was calculated and set as a comparative baseline

Two coated brass wheel segments of Example 5 were prepared and wear tested. After 200,000 cycles the slope of was calculated as 0.302-9.3 times the slope of Comparative Example 3. The higher slope signifies a greater loss of material per 10,000 cycles.

Two coated brass wheel segments of Example 5 were prepared and wear tested. After 200,000 cycles the slope of was calculated as 0.093-2.9 times the slope of Comparative Example 3.

TABLE 6
Three Body Wear Results of Polymer Coated Segments

| | Measured slope | Ratio |
|---|---|---|
| Example Material | (μm/1000 cycles) | to Z250 |
| Z250 composite, A1 shade | 0.032 | 1 |
| Example 5 | 0.302 | 9.3 |
| Example 6 | 0.093 | 2.9 |

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A method for coating a dental article comprising:
providing a body comprising a metal substrate;
priming at least a portion of a surface of the body;
depositing a ceramic material on at least a portion of a surface of the body, wherein said depositing forms a ceramic layer bonded directly to the surface; and
depositing at least one hardenable composition comprising a polymerizable component on at least a portion of the ceramic layer, wherein depositing at least one hardenable composition forms a polymeric layer.

2. The method of claim 1, further comprising applying a bonding layer to at least a portion of the outer surface, wherein the bonding layer is selected from the group consisting of:
silane and zirconate.

3. (canceled)

4. The method of claim 1, wherein depositing the ceramic layer comprises creating a continuous ceramic layer over at least a portion of the surface.

5. The method of claim 1, wherein the dental article is a stainless steel crown having a height of contour and a surface for contact with the opposing dentition, and wherein the ceramic material is deposited on the outer surface of the crown substantially above the height of contour.

6. The method of claim 1, further comprising creating a discontinuous ceramic layer ablating at least a portion of the ceramic layer to form a discontinuous ceramic layer.

7. (canceled)

8. (canceled)

9. The method of claim 1, wherein depositing a ceramic material comprises creating a discontinuous ceramic layer via deposition.

10. The method of claim 1, wherein the ceramic material is selected from the group consisting essentially of: alumina, zirconia, yttria, yttria-stabilized zirconia, porcelain, and combinations thereof.

11. The method of claim 1, wherein the poymerizable component comprises at least one (meth)acrylate monomer.

12. method of claim 1, wherein the polymerizable component is selected from the group consisting of phenoxoyethyl methacrylate, urethane dimethacrylate, polyethylene glycol methacrylate, polypropylene glycol methacrylate, triethyleneglycol dimethacrylate, the diglycidyl methacrylate of bisphenol A, and combinations thereof.

13. (canceled)

14. The method of claim 1, wherein a hybrid coating layer comprises the ceramic layer and the polymeric layer, and wherein the hybrid coating layer has a thickness of no greater than 250 microns above the height of contour.

15. The method of claim 1, wherein the thickness of the ceramic layer on a wall surface of the crown is less than the thickness of the ceramic layer on the occlusal surface.

16. (canceled)

17. A dental article comprising:
a first layer of material disposed on and bonded directly to at least a portion of a surface of the dental article, wherein the first layer comprises a ceramic material;
a second layer of material disposed on at least a portion of the ceramic material, wherein the second layer comprises at least one hardened composition comprising a polymerizable component.

18. The dental article of claim 17, wherein the dental article is a crown having a surface for contact with the opposing dentition and a height of contour proximate said contact surface; and wherein the ceramic material is disposed on at least a portion of outer surface substantially above the height of contour.

19. The dental article of claim 17, wherein the ceramic material is selected from a group consisting of alumina, zirconia, yttria, yttria-stabilized zirconia, porcelain, and combinations thereof.

20. The dental article of claim 17, wherein the first layer is a discontinuous ceramic layer.

21. The dental article of claim 20, wherein the discontinuous ceramic layer extends over at least a portion of the outer surface above the height of contour.

22. (canceled)

23. The article of claim 17, wherein the polymerizable component is selected from the group consisting of phenoxoyethyl methacrylate, urethane dimethacrylate, polyethylene glycol methacrylate, polypropylene glycol methacrylate, triethyleneglycol dimethacrylate, the diglycidyl methacrylate of bisphenol A, and combinations thereof.

24. (canceled)

25. The article of claim 17, wherein the polymerizable component further comprises a core-shell polymer compound.

26. (canceled)

27. The article of claim 17, wherein a hybrid coating layer comprises the ceramic layer and the polymeric layer, and wherein the hybrid coating layer has a thickness of no greater than 250 microns.

28. (canceled)

29. (canceled)

30. A kit comprising:
At least one crown;
at least one hardenable composition comprising a polymerizable component, an initiator system, a pigment, and filler;
at least one of a cement, a brush, and instructions for application of the ceramic material and at least one hardenable dental composition.
